(19) United States
(12) Patent Application Publication
(10) Pub. No.: US 2012/0195198 A1
(43) Pub. Date: Aug. 2, 2012

(54) METHOD AND APPARATUS PROVIDING PROTOCOL POLICING

(76) Inventor: Joseph Regan, Auburn, CA (US)

(21) Appl. No.: 13/227,875

(22) Filed: Sep. 8, 2011

Related U.S. Application Data
(60) Provisional application No. 61/438,028, filed on Jan. 31, 2011.

(51) Int. Cl. H04L 12/24; H04L 12/56

(52) U.S. Cl. 370/235

(57) ABSTRACT

A method and apparatus providing policing of control plane protocols such as in computer network routing or switching devices.

### CROSS-REFERENCE TO RELATED APPLICATION

Applicant claims the benefit of prior provisional patent application Ser. No. 61/438,028, filed Jan. 31, 2011, which application is incorporated herein by reference.

### FIELD OF THE INVENTION

The invention relates to the field of communication networks and, more specifically, to traffic management in such networks using granular policing.

### BACKGROUND OF THE INVENTION

Routers are typically architected with a buffer or traffic queue structure in which traffic or data flows passing through the router are buffered by various buffers or queues depending upon the input port from which the data flow is received, the output port to which the data is transmitted, and the switching element or elements (switching fabric) used to route the data between the input and output ports.

Each buffer is typically managed using a policing function in which traffic flows through the buffer are policed based upon class, service level, priority and so on. Various policing functions include Committed Information Rate (CIR), Peak Information Rate (PIR), Maximum Information Rate (MIR) and so on, where each policer function operates to mark packets for subsequent discard according to particular criteria. Typically, CIR<=PIR<=MR<=line rate.

PIR Buckets utilize red or green states to mark packets for discard; a PIR bucket is used for any type of buffer and indicates whether an overflow condition exists (red) or does not exist (non-red state). CIR Buckets utilize green or yellow states to mark packets for discard; a CIR bucket is class oriented and used for buffers operating on particular classes of traffic (e.g., voice, streaming media, non-priority data and the like).

Present policer solutions provide control plane policing of buffers on an aggregate basis. Unfortunately, this aggregate basis operation sometimes leads to a situation where traffic of one protocol (e.g., voice) can “starve out” traffic of another protocol (e.g., video).

### SUMMARY OF THE INVENTION

Various deficiencies in the prior art are addressed through the invention of a method, apparatus and system providing control plane policing of buffers on a per item protocol basis rather than an aggregate basis.

Various embodiments provide multiple levels of policer buckets (e.g., FIR, CIR and/or PIR) per protocol, and use packet-based rate calculations instead of byte based rate calculations. In some embodiments, each pursuing policer bucket decrements at a different rate (e.g. 1, 2, 10 respectively) of packets per time period, e.g. 1 second.

One embodiment is a method for policing packets associated with a control plane protocol, the method comprising: instantiating a protocol-based policer comprising at least two policers configured to control respective parameters of a traffic flow associated with the control plane protocol, each of the policers configured for packet level policing of its respective traffic flow; monitoring traffic associated with the control plane protocol; and in response to the monitoring, adapting the operation of at least one of the policers configured to control respective parameters of the traffic flow associated with the control plane protocol.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an apparatus benefiting from embodiments of the present invention;

FIG. 2 depicts a high-level block diagram of a network element portion according to one embodiment;

FIG. 3 depicts a high-level block diagram of a protocol policer suitable for use in the network element portion of FIG. 2;

FIG. 4 depicts a method according to one embodiment of the present invention; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

Various embodiments provide control plane policing of buffers on a per-protocol basis rather than an aggregate basis. For example, some embodiments provide multiple levels of policer buckets (e.g., FIR, CIR and/or PIR) per protocol, and use packet-based rates instead of the byte based rates used with typical policing in the data plane. Each policer bucket decrements at a different packet rate (e.g. 1, 2 and 10 packets per second for, respectively, FIR, CIR and PIR policers) of packets per time period such as a one second time period.

Some policer arrangements make a decision to mark packets for discard typically based upon a comparison of an actual number of bytes per second associated with a policed traffic flow and an allowed number of bytes per second. This type of arrangement may break down within the context of different types of traffic, different protocols and the like where the number of bytes in any one packet is different.

The invention advantageously allows for the control of traffic rates of specific protocols, such as those that primarily require router control plane resources, such as Address Resolution Protocol (ARP), Dynamic Host Configuration Protocol (DHCP) and the like. By providing a finer granularity of control over the use of control plane resources, the embodiments help to ensure a fair use of resources over mix of traffic and enable a more targeted mitigation of DoS attacks.

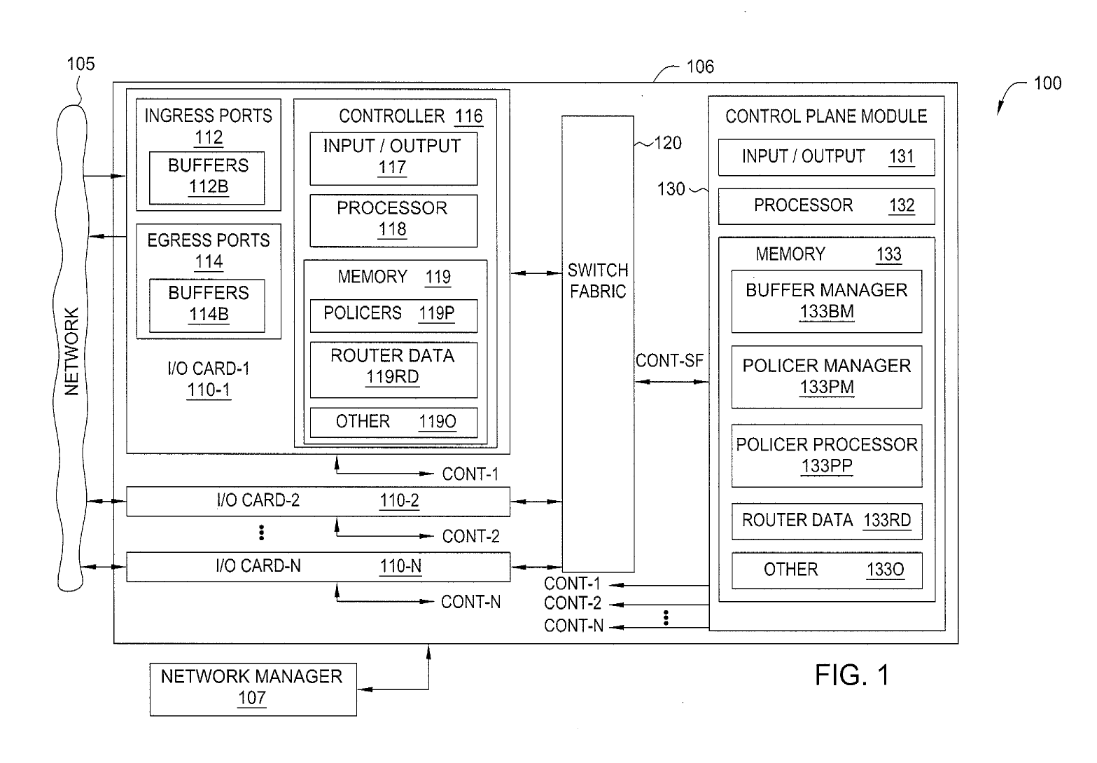

FIG. 1 depicts a high-level block diagram of an apparatus benefiting from embodiments of the present invention. Specifically, FIG. 1 depicts a router 106 in communication with a network 105 and a network manager 107.

The router 106 includes a plurality of input output (I/O) cards 110-1, 110-2 and so on up to 110-N (collectively I/O cards 110), a switch fabric 120 and a control plane module 130. The control plane module 130 controls the operation of the I/O cards 110 and switch fabric 120 by respective control signals CONT.

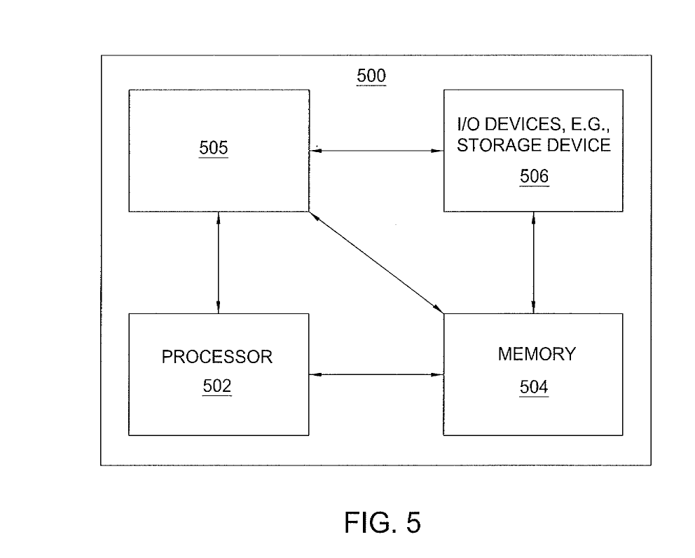

Each of the I/O cards 110 includes a plurality of ingress ports 112 including corresponding ingress port buffers 112B, a plurality of egress ports 114 including corresponding egress port buffers 1148, and a controller 116 including an I/O module 117, a processor 118 and memory 119. The memory 119 is depicted as including software modules, instantiated objects and the like to provide policers 119P, routing data 119RD and other functions 1190. The controller 116 may be implemented as a general purpose computing device or specific purpose computing device, such as described below with respect to FIG. 5.

The I/O cards 110 operate to convey packets between the network 105 and the switch fabric 120. Packets received at a particular ingress port 112 of an I/O card 110 may be conveyed to the switch fabric 120 or back to the network 105 via a particular egress port 112 of the I/O cards 110. Routing of packets via the I/O cards 110 is accomplished in a standard manner according to routing data provided by the control plane module 130, which may be stored in the routing data portion of memory 119.

The switch fabric 120 may comprise any standard switch fabric such as electrical, optical, electro-optical, MEMS and the like.

The control plane module 130 receives from a network manager 107 configuration data, routing data, policy information, policer information and other information pertaining to various management functions. The control plane module 130 provides management and operations data to the network manager 107, including data such as configuration data, status data, alarm data, performance data and the like.

The control plane module 130 comprises an I/O module 131, a processor 132 and memory 133. The memory 133 is depicted as including software modules, instantiated objects and the like to provide a buffer manager 133BM, a policer manager 133PM, a policy processor 133PP, routing data 133RD and other functions 1330. The control plane module 130 may be implemented as a general purpose computing device or specific purpose computing device, such as described below with respect to FIG. 5.

The buffer manager 133BM operates to manage the configuration of the various policers such that they conform to the buffer structure provided by, illustratively, ingress ports, egress ports, switch fabric and so on. The buffer manager 133 BM also interacts with the various buffers to determine whether soft or hard limits have been reached, such as an overutilization warning limit (e.g., 80% of buffer utilization level), an overutilization alarm limit (e.g., 95% of buffer utilization level) and so on of the buffers operative within the context of the router 106.

The policer manager 133PM operates to define and manage the various policers to be instantiated at, illustratively, the I/O cards 110. The policer manager 133PM communicates the number, type, operating parameters and/or other characteristics of policers to be instantiated within the context of the router 106.

The policy processor 133PP operates to process policy information such as service level agreement (SLA), traffic classification constraints, subscriber/user constraints, differentiated service levels, differentiated QoS levels/parameters and, generally, any other policy related parameter impacting the number, type, operating parameters and/or other characteristics of the policers to be instantiated within the context of the router 106.

The routing data 133RD operates to process routing information such that packets or traffic flows received at ingress ports are routed to appropriate egress ports within the context of the router 106. The routing data 133RD may include routing tables, protection or fault recovery information and so on.

The various managers discussed above also operate to monitor the impact of protocol-based policers upon their respective control plane protocols. Specifically, assuming a particular control plane protocol is associated with a plurality of related data plane traffic flows, policing those related data plane traffic flows will impact the bandwidth utilization, packet rate and/or other parameters associated with the respective control plane protocol. Thus, monitoring the particular control plane protocols to identify the impact of data plane policing of related traffic flows is provided in various embodiments.

The control plane protocol monitoring function may be implemented by the buffer manager 133BM, the policer manager 133PM, the policy processor 133PP or any other network management element capable of monitoring changes in the behavior of control plane protocol information or traffic. It is noted various embodiments use existing control plane protocol monitoring functions to gauge policer impact on the particular protocol.

Generally speaking, policers 119P instantiated at various I/O cards 110 or switch fabric 120 are defined in terms of parameters conveyed by the policer manager 133PM in accordance with the policing goals defined by the policy processor 133PP.

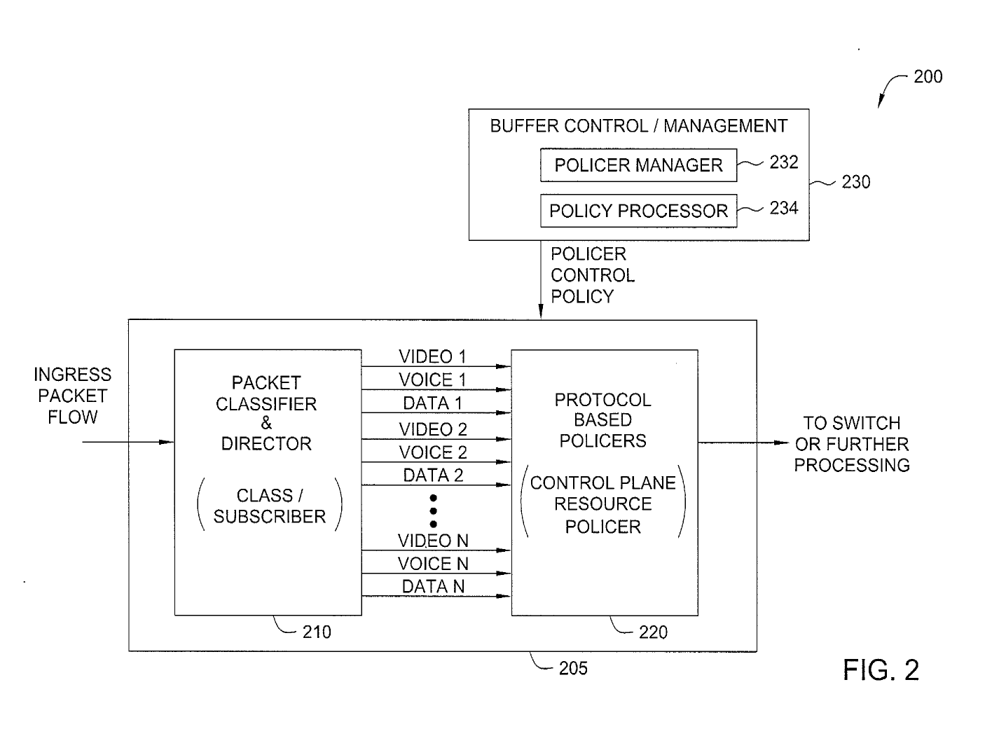

FIG. 2 depicts a high-level block diagram of a network element portion according to one embodiment. For example, FIG. 2 may be implemented within the context of an ingress card in a packet routing or switching system wherein only those packets corresponding to specific policed functions are coupled to a switching fabric for subsequent routing to a destination.

A packet classifier and director 210 receives an ingress packet flow and responsively classifies the packets according to, illustratively, video, voice, data or other classifications. Such other classifications may include subscriber ID, service provider ID, application ID, protocol and the like. Broadly speaking, various embodiments enable protocol-related classification of packets via packet classifier and director 210.

Packet classifier and director 210 routes streams of classified packets to protocol based policers 220. The packet classifier and director 230 may be instantiated function within the memory 119 of the I/O card 110 discussed above with respect to FIG. 1.

Protocol based policers 220 implement a protocol based policing function according to embodiments of the invention. In one embodiment of the invention, a specific cost structure is derived from a service level agreement (SLA) and enforced using the protocol based policers 220.

The packet classifier and director 230 and the protocol based policers 220 may be implemented in an environment 205 comprising hardware, software or combination thereof.

In one embodiment, a buffer control/management function 230 includes a policer manager 232 and a policy processor 234. The policy processor 234 adapts policy information associated with service level agreements (SLAs) or other policy sources to define how various buffers within a router, switching device or other system should behave. The policer manager 232 is used to instantiate policers in a manner implementing the policy-based buffer behavior. The buffer control/management function 230 provides policer control policy information and intermediate arbiter information to the software environment 205 implementing the packet classifier and director 230 and the protocol based policers 220.

The inventors determined that one difficulty is setting the packet-based decrement rates appropriately for each protocol so that the policing is effective without “starving” out the protocol. For example, an ARP exchange requires an exchange of 2 messages/packets of about 100 bytes each, whereas a typical DHCP exchange requires an exchange of 4 messages/packets. A bucket threshold of 2 packets would allow a complete ARP exchange, however the same threshold would stifle DHCP exchanges because it would never allow a complete exchange to occur (where a complete exchange needs 4 packets/messages).

The inventors also determined that another difficulty existed with regard to the selection and use of available system timers to implement a desired time period used to enforce a given policing rate. Although the number of timers available on a system varies, typically because of their cost there are only a dozen or so timers. Therefore, in order to minimize the number of timers needed, the control plane policing function of the various embodiments uses timer prescalers to achieve various rates from a single timer.

Timers implemented with registers enable a simple prescaling function to be achieved with simple left (or right) bit shifting for scaling in powers of two (i.e. shift of N bits left results in 2N scaling). For the example given above the FIR, CIR, and PIR buckets could have prescalers of 1, 2, and 8 respectively to achieve the desired policing rates. For a policy rate of 10 packets/second, e.g. for the PIR bucket, a second timer (and optional prescaler) would be needed. Therefore, since the various protocols will require respective policing rates in order to enable complete exchanges without unduly high policing rate limits, the solution provides an efficient trade-off between timer and prescaler resources versus granularity of configurable policing rates.

The various embodiments work in conjunction with, illustratively, per-subscriber based policing, such as used within the context of the Alcatel-Lucent 7750 Service Router. The result will enable per-subscriber and per-protocol policing. Being able to police control plane traffic with subscriber and/or protocol granularity is particularly advantageous to ensure fair control plane usage between subscribers as well as mitigating denial of service (DoS) attacks on the control plane of, illustratively, a router.

Therefore, since the various protocols will require respective policing rates in order to enable complete exchanges without unduly high policing rate limits, the solution provides an efficient trade-off between timer and prescaler resources versus granularity of configurable policing rates.

Generally speaking, various embodiments provide apparatus, methods and/or systems configured to police packets associated with a plurality of service consuming entities within a group of service consuming entities where different service consuming entities may be consuming services via different protocols or service mechanisms. Various embodiments discussed herein find particular applicability to effecting policing function capable of moderating bandwidth consumption based on control plane considerations, such as subscriber protocol and the like.

Policing parameters that may be adapted in response to information received from atomically coupled downstream policer include, illustratively, minimum/guaranteed bandwidth, maximum/allowed bandwidth, average bandwidth, priority or other quality of service (QoS) parameter. These policing parameters may be adapted in response to signals received from the policy manager 232, policy processor 234 or other control/management elements.

It should be noted that while the packet classification function and packet routing/director function are depicted as being implemented by a single functional element, it will be appreciated that multiple functional elements may be used to implement these functions. In particular, in various embodiments, the packet classifier is used to classify all incoming traffic. Any specific processing functions such as per-subscriber, per-site or, more generally, per-entity processing functions are addressed by other functional elements.

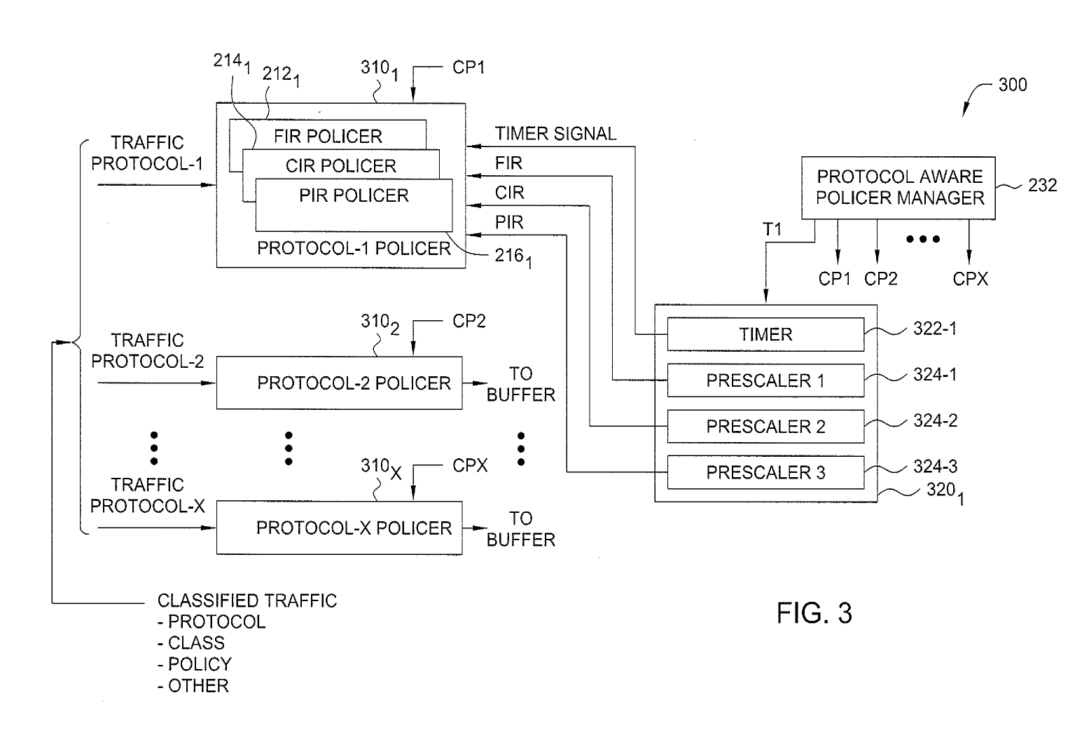

FIG. 3 depicts a high-level block diagram of a protocol-based policer embodiment suitable for use in the network element portion of FIG. 2. Specifically, FIG. 3 depicts a plurality of protocol-based policers 310₁, 310₂ and so on up to 310ₓ (collectively protocol-based policers 310), where each protocol-based policer operates to police its respective traffic flow having a respective protocol parameter according to each of a respective plurality of policer functions. In embodiment of FIG. 3, each of the protocol-based policers includes an FIR policer 212, a CIR policer 214 and a PIR policer 216. In other embodiments, more or fewer policer functions may be utilized. Moreover, multiple policer functions of the same type may also be utilized.

Each of the protocol-based policers 310 is responsive to a respective control signal CP provided by a protocol aware policer manager 232. The protocol aware policer manager 232 adapts the operating characteristics of the protocol policers 310, or the various policer functions included therein, such that a protocol-based or policy-based policing function is implemented using multiple policers.

Each of the protocol-based policers 310 is responsive to a respective timing source 320 which is operative to provide various timing signals. Illustratively, a timing source 320₁ is depicted as including a timer 322, a first prescaler 324₁, a second prescaler 324₂ and a third prescaler 324₃. The timer 322 provides a timer signal to first protocol-based policer 310₁. The first, second and third prescaler 224 provide respective timing signal to the FIR policer 212, CIR policer 214 and PIR policer 216 of first protocol-based policer 310₁.

Each of the timing sources 320 is responsive to a respective control signal T provided by the protocol aware policer manager 232. For example, the protocol aware policer manager 232 optionally adapts the scaling or timing relationships between the various pluralities of policers used to implement any one protocol-based policer 310. In this manner, different packet data rates associated with the plurality of policers processing traffic according to a single protocol may be provided such that extremely detailed control of the user experience, traffic flow profile, service level and so on associated with the streams included within the policed protocol is provided.

It is noted that the arrangement of FIG. 3 depicts a respective and distinct timing source 320 for each of the protocol-based policers 310. Moreover, the depicted timing source 320 includes a plurality of prescalers 324. In various embodiments, a single timing source 320 is used for all of the protocol-based policers 310. In this embodiment, any adaptation of the provided timing signal or signals is made proximate to the instantiated policer functions supporting the particular protocol-based policers 310.

In one embodiment, a single timer signal is used by any one of the protocol-based policers 310. In this embodiment, the plurality of included policers may use the single timer signal or a timer signal derived therefrom, such as via a scaler or other clock/frequency divider function.

In one embodiment, a single or common timer signal is used by each of the protocol-based policers 310. In this embodiment, the plurality of included policers may use the single timer signal or a timer signal derived therefrom, such as via a scaler or other clock/frequency divider function.

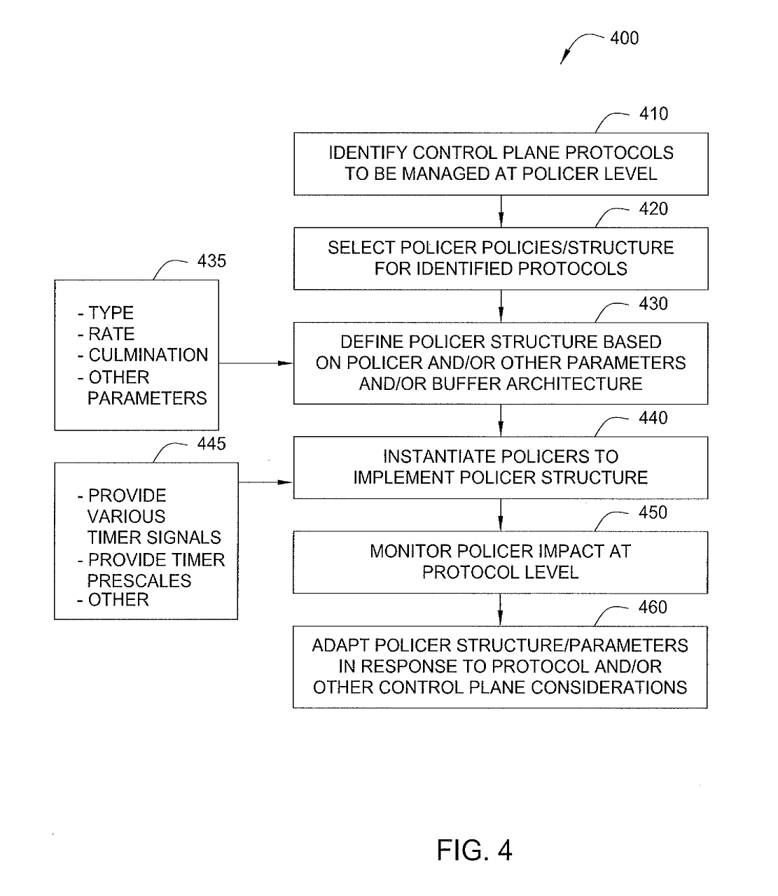

FIG. 4 depicts a flow diagram of a method according to one embodiment. Specifically, FIG. 4 depicts a method suitable for implementing and adapting the operation of protocol-based policers such as described above.

At step 410, control plane protocols to be managed at a policer level are identified. Such identified protocols may include those associated with a specific subscriber, group of subscribers, service providers, types of users or traffic and so on. Other identified protocols may include specific types of traffic or traffic managed according to specific network management techniques or protocols. Generally speaking, the identified control plane protocols comprise those which, when policed at a high-level or component level, allow for the precise control of router control plane resources (e.g., ARP, DHCP, etc.).

At step 420, policer policies and/or structure associated with the identified protocols are selected. That is, a selection is made as to the underlying policies or structures that support a particular protocol so that a policer configuration may be adapted to control such underlying policies and structures.

At step 430, a selection is made of a policer structure based on the policy and/or other parameters, as well as the buffer architecture of the system. Referring to box 435, the policer structure may include policer type, police rate, the combination of type/rate and or other parameters.

At step 440, policers are instantiated to implement the defined policer structure. Referring to box 445, various timer signals, timers, prescalers and other functions are provided or instantiated as necessary to support the instantiated policers.

At step 450, the impact of the instantiated policers is monitored at the protocol level. That is, assuming a protocol level monitoring associated with a particular subscriber, the various policers used to implement a protocol-based policer 310 associated with that subscriber will have an impact upon the user experience, bandwidth consumption, quality of service and the like. In addition, various control plane protocol level parameters are monitored to ensure compliance with service level agreement and the like.

At step 460, the policer structure and/or parameters associated with the instantiated policers or timers is adapted in response to protocol and/or other control plane considerations. For example, the monitored impact of policer functions at step 450 may indicate that a particular subscriber is unduly constrained in terms of consumption (e.g., with respect to a SLA) or over utilizing one or more specific components associated with consumption. At step 460 the method will adapt the policer structure, timing parameters and the like in a manner tending to cause subscriber consumption to conform with the corresponding subscriber SLA.

In various embodiments, the policers are implemented as a leaky bucket or a state machine. Various embodiments provide hardware policing; others use hardware and software to make the policing adaptive with regards to various policies, priorities and so on. Decisions to discard or not discard a packet are made based on color (priority) and the like. The output of policers is per-packet accurate.

Dropped packets may be those associated with specific criteria, such as customer service level (e.g., gold, silver or bronze QoS service levels), traffic flow error correction ability (e.g., traffic flows with very robust FEC or other schemes), traffic flow type (e.g., voice, streaming video, streaming audio, bulk file or data transfers and the like), input port, output port and so on. Essentially, packets are dropped according to a hierarchical order based on one or more of the criteria.

An FIR bucket (blue/orange state) is optionally used to select a threshold value within its parent policer, such as a CIR or PIR policer within the same protocol-based policer 310. That is, in response to a change in state associated with an FIR child buffer policer, the threshold level associated with a CIR or PIR policed buffer is adapted such that bandwidth is not wasted by constraining specific traffic flows that do not need to be constrained.

FIG. 5 depicts a high-level block diagram of a general purpose computer suitable for use in performing the functions described herein. As depicted in FIG. 5, system 500 comprises a processor element 502 (e.g., a CPU), a memory 504, e.g., random access memory (RAM) and/or read only memory (ROM), a packet processing module 505, and various input/output devices 506 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It will be appreciated that computer 500 depicted in FIG. 5 provides a general architecture and functionality suitable for implementing functional elements described herein and/or portions of functional elements described herein. Functions depicted and described herein may be implemented in software and/or hardware, e.g., using a general purpose computer, one or more application specific integrated circuits (ASIC), and/or any other hardware equivalents.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, transmitted via tangible media and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for policing packets associated with a control plane protocol, the method comprising:
instantiating a protocol-based policer comprising at least two policers configured to control respective parameters of a traffic flow associated with the control plane protocol, each of said policers configured for packet level policing of its respective traffic flow;
monitoring traffic associated with the control plane protocol; and
in response to said monitoring, adapting the operation of at least one of the policers configured to control respective parameters of the traffic flow associated with the control plane protocol.

2. The method of claim 1, wherein each of a plurality of control plane protocols is policed by a respective protocol-based policer.

3. The method of claim 1, wherein said protocol-based policer comprises a CIR policer and a PIR policer.

4. The method of claim 3, wherein said protocol-based policer further comprises a FIR policer.

5. The method of claim 4, wherein the FIR policer is atomically coupled to at least one of the at least two policers.

6. The method of claim 4, wherein the FIR policer is adapted to select a threshold value within its respective parent policer.

7. The method of claim 1, wherein each of the at least two policers performs packet level policing using a respective timer signal.

8. The method of claim 7, wherein the timer signal associated with one of the policers is derived by scaling the timer signal associated with another policer.

9. The method of claim 1, wherein at least one of the at least two policers is implemented as a leaky bucket state machine.

10. The method of claim 1, wherein the protocol-based policer is configured using parameters selected to enforce a service level agreement (SLA) associated with the control plane protocol.

11. The method of claim 10, wherein the selected parameters include one or more of a policer structure parameter and a timing parameter.

12. The method of claim 1, wherein the control plane protocol comprises any of a subscriber protocol, a subscriber group protocol, a service provider protocol, an application protocol, a traffic class protocol and a communications protocol.

13. The method of claim 12, wherein the control plane protocols comprises one of an Address Resolution Protocol (ARP) and a Dynamic Host Configuration Protocol (DHCP).

14. The method of claim 10, wherein packets to be dropped are selected according to a hierarchical order.

15. The method of claim 14, wherein the hierarchical order is defined according to a customer service level.

16. The method of claim 14, wherein the hierarchical order is defined according to a traffic flow error correction capability.

17. The method of claim 14, wherein the hierarchical order is defined according to at least one of a traffic flow type and a port type.

18. An apparatus for policing packets associated with a control plane protocol, the method comprising:
a protocol-based policer comprising at least two policers configured to control respective parameters of a traffic flow associated with the control plane protocol, each of said policers configured for packet level policing of its respective traffic flow; and
a control plane protocol monitor in communication with the protocol-based policer;
wherein, in response to a signal from the control plane protocol monitor, the protocol-based policer responsively adapts the operation of at least one of the policers configured to control respective parameters of the traffic flow associated with the control plane protocol.

19. A computer readable medium including software instructions which, when executed by a processes, performs a method for policing packets associated with a control plane protocol, the method comprising:
instantiating a protocol-based policer comprising at least two policers configured to control respective parameters of a traffic flow associated with the control plane protocol, each of said policers configured for packet level policing of its respective traffic flow;
monitoring traffic associated with the control plane protocol; and
in response to said monitoring, adapting the operation of at least one of the policers configured to control respective parameters of the traffic flow associated with the control plane protocol.

20. A computer program product, wherein a computer is operative to process software instructions which adapt the operation of the computer such that computer performs a method for policing packets associated with a control plane protocol, the method comprising:
instantiating a protocol-based policer comprising at least two policers configured to control respective parameters of a traffic flow associated with the control plane protocol, each of said policers configured for packet level policing of its respective traffic flow;
monitoring traffic associated with the control plane protocol; and
in response to said monitoring, adapting the operation of at least one of the policers configured to control respective parameters of the traffic flow associated with the control plane protocol.
